(19) United States
(12) Patent Application Publication
(10) Pub. No.: US 2020/0109533 A1
(43) Pub. Date: Apr. 9, 2020

(54) PORTABLE MINI DYNAMIC PENETRATION AND TORQUE (MDPT) DEVICE

(71) Applicant: North Carolina State University, Raleigh, NC (US)

(72) Inventors: Mohammed Mulla, Raleigh, NC (US); Mohammed Gabr, Raleigh, NC (US); Shamim Rahman, Raleigh, NC (US)

(21) Appl. No.: 16/596,985

(22) Filed: Oct. 9, 2019

Related U.S. Application Data
(60) Provisional application No. 62/742,985, filed on Oct. 9, 2018.

(51) Int. Cl. E02D 1/02; G01N 3/34

(52) U.S. Cl. CPC E02D 1/022; G01N 2203/0039; G01N 3/34

(57) ABSTRACT

Portable mini dynamic penetration test (MDPT) device includes a probe for penetrating into soil, the probe defining a cylinder with a cone head at a distal end of the probe and a rod attached at a proximal end of the probe, and a drive-weight assembly for driving the probe into soil, the drive-weight assembly including an approximately 17.5 lb hammer. In operation, the MDPT device is configured for use by an operator, wherein the operator can carry the MDPT device to a soil test site, set up the MDPT device at the soil test site, and test soil condition at the test site with the MDPT device.

### CROSS-REFERENCE TO RELATED APPLICATIONS

This application claims priority to U.S. Provisional Patent Application No. 62/742,985 filed on Oct. 9, 2018, the entire contents of which are incorporated by reference herein.

### TECHNICAL FIELD

The present invention relates generally to the field of geotechnical engineering for site characterization, and more particularly, to systems and devices disclosed for estimating engineering properties of soils.

### BACKGROUND

The designing of engineering foundation systems typically relies primarily on in-situ and laboratory soil testing to determine soil properties. Evaluation of proper compaction, bearing capacity, and soil properties is essential for foundation design and quality control during the construction of highway and commercial and residential projects. It is important to assess and verify soils' design parameters in the field to insure the soil has adequate strength to carry the required loads prior to construction. Understanding soil strength and other engineering properties is essential for the adequate foundation design particularly when assessing the load-carrying capacity of the underlying loose and soft in-situ soils during design and construction. Monitoring miles of subgrade and roadway embankments for adequate compaction also requires a large number of tests. In-situ penetration tests are widely used in geotechnical engineering to estimate soil parameters or the analysis and design of foundation systems. The Standard Penetration Test (SPT) and the Cone Penetration Test (CPT) are two most widely used field testing procedures in the United States for foundation design and analysis.

Most common in-situ tests require either the use of conventional drilled borings or specialized rigs, whereas specialized tests require a separate borehole or different insertion equipment. Oftentimes soil exploration for small and simple projects tend to cost as much as complex projects, because the cost associated with the use of conventional methods such as SPT (Standard Penetration Test) and Cone Penetration Test (CPT) are often indifferent to the project size/scope. The costs in these cases are usually based on factors such as equipment and crew mobilization, number and depth of holes to be made, location of the project, and time to complete the project. In addition, the test equipment and procedures for geotechnical applications are not as advanced as in other engineering disciplines. Furthermore, limitations exist with respect to the site mobility and accessibility of test equipment used in evaluating the soil layers.

Opportunities exist for developing a simpler and more cost-effective procedure to determine in-situ soil parameters whereby geotechnical engineers are able to perform analyses, design, and quality control work with data and methods that are more convenient and less equipment and labor-intensive than conventional methods.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

Disclosed herein is a system for in-situ soil testing, the system comprising a portable mini dynamic penetration test (MDPT) device including a probe for penetrating into soil, the probe defining a cylindrical shape with a cone head (or a cylinder with a cone head) at a distal end of the probe and a rod attached at a proximal end of the probe, and a drive-weight assembly for driving the probe into soil, the drive-weight assembly including an approximately 17.5 lb hammer, whereby, in operation, the MDPT device is configured for use by an operator, wherein the operator can carry the MDPT device to a soil test site, set up the MDPT device at the soil test site, and test soil condition at the test site with the MDPT device.

According to one or more embodiments, the drive-weight assembly comprises a hammer configured to provide an approximately 24 inch drop in height for driving the probe into the soil.

According to one or more embodiments, the system further comprises an extension rod with a coupler for coupling to the rod.

According to one or more embodiments, the system further comprises a torque wrench and/or a torque adaptor for the torque wrench configured to rotate the probe.

According to one or more embodiments, the cone head makes a 60 degree apex angle.

According to one or more embodiments, the drive-weight assembly is configured for application of approximately 35 ft-lb energy to drive the probe into soil.

According to one or more embodiments, the system is configured to measure a penetration depth of the probe for each blow of the drive-weight assembly.

The system of claim 1, wherein the system is configured to measure a number of blows MDPT-n required for the probe to penetrate the soil by half a foot, one foot, or depth per blow.

According to one or more embodiments, the probe is configured to be driven to a depth of at least 45 feet below a ground surface.

According to one or more embodiments, the system is configured for manual operation.

According to one or more embodiments, the probe (including the cone tip) is configured to be left inside the soil after completion of soil test.

According to one or more embodiments, the system is configured for automatic operation using a gear motor.

According to one or more embodiments, the system is configured to measure a unit skin friction value of the probe surface (MDPT fs) when the probe is rotated by application of a torque (MDPT-t).

According to one or more embodiments, the system is configured to measure soil shear strength.

According to one or more embodiments, one or more of the probe and the rod comprise stainless steel.

According to one or more embodiments, one or more of the probe and the rod comprise of steel.

According to one or more embodiments, the rod has a diameter of approximately ⅝^{th} of an inch.

According to one or more embodiments, the cylindrical shape with cone head has a diameter of approximately 1 inch.

According to one or more embodiments, the spacing between adjacent test sites is configured based on soil type.

According to one or more embodiments, the system is configured for calibrating test results obtained from the MDPT device by comparing them to a standard penetration test SPT (N) value, a cone penetration test (CPT) value, a tip resistance (qt) values, and a dry density (γd) value obtained from conventional equipment.

According to one or more embodiments, a number of blows required for the probe to penetrate the soil by one foot (MDPT-n) is related to a dry density value of the soil.

According to one or more embodiments, a number of blows required for the probe to penetrate the soil by one foot (MDPT-n) is related to a moisture content of the soil.

According to one or more embodiments, a number of blows required for the probe to penetrate the soil by one foot (MDPT-n) is related to a Dynamic Cone Penetrometer (DCP) blow count obtained from conventional equipment (NCDOT DCP).

According to one or more embodiments, a number of blows required for the probe to penetrate the soil by one foot (MDPT-n) is related to a standard penetration test count (SPT-N) obtained from conventional equipment.

According to one or more embodiments, a number of blows required for the probe to penetrate the soil by one foot (MDPT-n) is related to an effective friction angle ϕ of the soil.

According to one or more embodiments, a unit skin friction value of the probe surface (MDPT fs) measured by the MDPT device is related to a cone penetration test sleeve friction value (CPT-fs) obtained from conventional equipment.

Disclosed herein is a method of in-situ soil testing. According to one or more embodiments, the method comprises providing a portable mini dynamic penetration test (MDPT) device, wherein the MDPT device includes a probe for penetrating into soil, the probe defining a cylinder with a cone head (or a cylindrical shape with a cone head) at a distal end of the probe and a rod attached at a proximal end of the probe, and a drive-weight assembly for driving the probe into soil, the drive-weight assembly including an approximately 17.5 lb hammer. The method further includes carrying of the MDPT device by an operator to a soil test site; and, testing soil condition at the test site with the MDPT device.

According to one or more embodiments, the method further includes applying approximately 35 ft-lb of energy to drive the probe into soil.

According to one or more embodiments, the method further includes measuring a penetration depth of the probe within soil for each blow to the probe by the drive-weight assembly.

According to one or more embodiments, the method further includes measuring a number of blows required for the probe to penetrate soil by one foot (MDPT-n).

According to one or more embodiments, the method further includes measuring a unit skin friction value of a surface of the probe (MDPT fs) when the probe is rotated by application of a torque of value MDPT-t.

According to one or more embodiments, the method further includes measuring soil shear strength with the MDPT device.

According to one or more embodiments, the method further includes calibrating test results obtained from the MDPT device by comparing them to one or more of: a standard penetration test SPT(N) value, a standard cone penetration test (CPT) value, a standard tip resistance (qt) value, and a standard dry density (γd) value, obtained from a conventional equipment.

According to one or more embodiments, the method further includes comparing a number of blows required for the probe to penetrate soil by one foot (MDPT-n) to one or more of: a standard penetration test count (SPT-N) obtained from conventional equipment, and a standard Dynamic Cone Penetrometer (DCP) blow count obtained from conventional equipment.

According to one or more embodiments, the method further includes comparing a unit skin friction value of a surface of the probe (MDPT fs) measured by the MDPT device with a cone penetration test sleeve friction value (CPT-fs) obtained from conventional equipment.

According to one or more embodiments, the method further includes using a number of blows required for the probe to penetrate soil by one foot (MDPT-n) to calculate one or more of: a dry density value of the soil, a moisture content of the soil, and an effective friction angle ϕ of the soil.

### BRIEF DESCRIPTION OF THE DRAWINGS

FIG. 1 is a structural schematic diagram of a system for in-situ oil testing that includes a portable mini dynamic penetration test (MDPT) device provided in accordance with some embodiments of the presently disclosed subject matter.

FIGS. 2A-2D illustrates structural schematic diagrams of various components of the system of FIG. 1 provided in accordance with some embodiments of the presently disclosed subject matter.

FIG. 3 illustrates a structural schematic diagram of various components of the system of FIG. 1 further including a torque wrench provided in accordance with some embodiments of the presently disclosed subject matter.

FIG. 4 illustrates a structural schematic diagram of the system of FIG. 1 with the torque wrench coupled to a rod attached to the probe the provided in accordance with some embodiments of the presently disclosed subject matter.

FIGS. 5-8 illustrate structural schematic diagrams of the probe and the rod attached thereto that form of the system of FIG. 1 provided in accordance with some embodiments of the presently disclosed subject matter.

FIG. 9 illustrates a structural schematic diagram of the system of FIG. 1 being operated by a human in accordance with some embodiments of the presently disclosed subject matter.

FIGS. 10A through 10C illustrate samples of correlations studies based on tests conducted with the system of FIG. 1, in accordance with some embodiments of the presently disclosed subject matter.

FIG. 11 illustrates a relationship between friction angle ϕ and MDPT-t (lb-ft) based on tests conducted with the system of FIG. 1, in accordance with some embodiments of the presently disclosed subject matter.

FIG. 12 illustrates a comparison between MDPT-t unit skin friction fs and CPT sleeve friction fs with depths based on tests conducted with the system of FIG. 1, in accordance with some embodiments of the presently disclosed subject matter.

FIGS. 13A through 13D illustrate the field testing results of the MDPT blows and the DCP blows cased on tests conducted with the system of FIG. 1, in accordance with some embodiments of the presently disclosed subject matter.

FIG. 14 illustrates a table showing the relationship between the cone tip resistance (qt) measured by the cone penetration test (CPT) and the effective friction angle ϕ′ of sands for different relative density ranging from very loose to very dense based on tests conducted with the system of FIG. 1, in accordance with some embodiments of the presently disclosed subject matter.

FIG. 15 illustrates tables showing the relationship between MDPT-n and dry density γd and moisture content based on tests conducted with the system of FIG. 1, in accordance with some embodiments of the presently disclosed subject matter.

FIG. 16 illustrates a table showing an overall comparison between the MDPT device and other in-situ test equipment based on tests conducted with the system of FIG. 1, in accordance with some embodiments of the presently disclosed subject matter.

### DETAILED DESCRIPTION

Below, the technical solutions in the examples of the present invention are depicted clearly and comprehensively with reference to the figures according to the examples of the present invention. Obviously, the examples depicted here are merely some examples, but not all examples of the present invention. In general, the components in the examples of the present invention depicted and shown in the figures herein can be arranged and designed according to different configurations. Thus, detailed description of the examples of the present invention provided in the figures below are not intended to limit the scope of the present invention as claimed, but merely represent selected examples of the present invention. On the basis of the examples of the present invention, all of other examples that could be obtained by a person skilled in the art without using inventive efforts will fall within the scope of protection of the present invention.

Below, the technical solutions set forth in the examples are depicted clearly and comprehensively with reference to the figures. It should be appreciated that the examples depicted herein are not limited to each and every embodiment of the presently disclosed subject matter. In general, the components in the disclosed examples and shown in the figures herein can be arranged and designed according to different configurations. Thus, detailed description of the examples of the present invention provided in the figures below are not intended to limit the scope of the presently disclosed subject matter as claimed, but merely represent selected examples. On the basis of the examples below, other examples that could be obtained by a person skilled in the art without using inventive efforts will fall within the scope of the presently disclosed subject matter.

Disclosed herein are methods, devices, and systems for a simpler, more cost-effective evaluation of in-situ parameters of natural and compacted soil layers using methods that are simpler and less equipment-intensive than SPT and CPT, and further less cumbersome to operate as compared to nuclear gauges. As such, the disclosed herein are methods to advantageously assist geotechnical engineers conduct their analyses and designs.

Understanding soil strength and other engineering properties are essential for the adequate design and analysis of foundations, particularly when assessing the load-carrying capacity of the underlying in-situ soil during design and construction. The engineering foundation system design relies primarily on in-situ and laboratory soil testing to determine soil properties. Currently, no portable, manual or automatic, economical, and easy-to-use field device exists that can measure these properties to depths of 45 ft. (13.7 m) or greater (for example, 50 ft., 100 ft., 150 ft., 200 ft., 250 ft., 300 ft. etc.) and verify bearing capacity during construction without auguring holes. The invention as described herein corresponds to a new and portable Mini Dynamic Penetration Test (MDPT).

In-situ penetration tests have been widely used in geotechnical engineering for site characterization for the analysis and design of foundations. The Standard Penetration Test (SPT) and the Cone Penetration Test (CPT) are widely used field testing procedures in the United States for foundation design and analysis. The current practice for soil testing according to the Federal Highway Administration (FHWA) and almost all state DOTs is the SPT and CPT for small or large projects.

The Standard Penetration Test (SPT) is the most common in-situ test for soil subsurface investigations. However, the Cone Penetration Test (CPT) is considered more reliable and more accurate than the SPT for soil characterization. The CPT is considered to be quick and CPT provides more accurate and continuous results than SPT. Many soil properties have been correlated to both the SPT and CPT. The SPT requires a drill rig whereas the CPT requires a specialized heavy instrumented truck to push the cone and annual calibration of the cone. Mobilizing a heavy drill rig or specialty truck can be very costly for a rushed or unplanned project or for a small project.

The Cone Penetration Test (CPT) was invented in Holland in 1932 and introduced into U.S. practice more than 50 years ago. Early field operations used mechanical systems that collected two readings, cone resistance (qt) and friction (fs), at 7.87-in (200-mm) intervals. Today, electric and electronic CPT systems are available in several sizes and cone tip configurations, and can provide three or more separate readings with depth, cone tip resistance (qt), sleeve friction (fs), and pore water pressure (u2), usually taken at frequent vertical intervals between 0.4 in-0.8 in (10 mm-20 mm). Dynamic cone penetrometers (DCPs) have been used in geotechnical applications for nearly 60 years. The DCP is used widely to evaluate pavement layers for pavement design such as base course material and subgrade soil. The DCP is performed by dropping a hammer from a certain fall height and measuring the penetration depth per blow for each tested depth. The DCP test is quick to set up, run, and evaluate on site, but it is designed to evaluate shallow soil layers at depths ranging from 2 ft.-6 ft. (0.67 m-1.8 m). In addition, the DCP has limitations with respect to its ability to evaluate the soil layers.

Proper compaction of roadway embankments and pavement foundation layers is essential to achieving stability and long-lasting pavement performance. According to the North Carolina Department of Transportation (NCDOT) compaction manual, embankment refers to any layer placed below the subgrade supporting pavement and other structures. The subgrade is usually 8 in-thick and refers to the portion of the roadbed prepared as a foundation for the pavement structure (including the curb and gutter). The quality of the pavement foundation is controlled by the properties of the foundation material and the degree of compaction. To ensure the suitability of the backfill or borrow materials, the soil is compacted in several layers to reach its maximum density. However, it is difficult to accurately measure proper compaction levels with the needed frequency of the soil density without the use of nuclear density gauges (NDG) during construction. Nuclear moisture density meters are most commonly used to determine soil density and water content at the same time. Despite the advantages of the nuclear method, it has many drawbacks including the handling and transportation of radioactive materials. For example, state DOTs are trying to replace NDGs due to various reasons including the reason that NDG involve radioactive materials that may be hazardous to operators of the NDG equipment as well as the need for secure storage and health and safety compliance.

Other available density devices, such as the rubber balloon and the sand cone methods, are also time- and labor-intensive. Most of these methods measure the degree of compaction effort up to only 1 ft (305 mm) and require a longer time to run each test. The increased testing frequency may delay construction and cause contractors to file claims in response. Verifying the degree of compaction in-situ is a major issue for many state DOTs due to the frequency and the quality control of the compaction process.

Embodiments of the presently disclosed subject matter provide for a portable mini dynamic penetration test (MDPT) device that can simulate both the SPT and CPT mechanisms. The MDPT device as disclosed herein further offers several benefits over other equipment such as nuclear gauges and other equipment currently in use. Embodiments of the presently disclosed subject matter can provide for a portable mini dynamic penetration test (MDPT) and process to estimate soil strength and engineering properties that have the following capabilities: (1) an apparatus that can be used to estimate soil properties at different depths; (2) an apparatus that can be used to perform a number of in-situ tests adjacent to the locations for which very few conventional in-situ tests such as SPT and CPT tests are available; (3) an apparatus that is versatile in terms of repeatability; (4) an apparatus that can be used to conduct analyses to provide empirical correlations between MDPT, SPT (automatic hammer), and CPT to estimate soil properties such as the friction angle ϕ; (5) an apparatus that can be used to estimate unit skin friction by developing a relationship between the MDPT-t torque and unit skin friction; and (6) an apparatus that can be used to develop a correlation between dry density and MDPT n-blow counts and create a field (QA/QT) process for compaction.

The use of a portable Mini Dynamic Penetration Test (MDPT) as described herein to collect data on penetration resistance and skin resistance can provide several advantages over traditional testing methods. The MDPT device as disclosed herein is portable and economical to use. A MDPT conducted using a MDPT device as disclosed herein supplemented with the measurement of torque (MDPT-t) measured by the MDPT device as disclosed herein can be used to obtain a direct measurement of soil unit skin friction (fs) (for e.g., by rotating the cylindrical cone with a calibrated torque wrench) quicker and more economically as compared to the CPT and SPT test equipment. A MDPT device capable of measuring a torque may be referred to hereinafter as a “MDPT-t device” or simply as “MDPT-t”.

The use of the MDPT procedure is simpler and less equipment-intensive than SPT and CPT. The MDPT can be driven to a depth of 45+ft (13.7+m) below the ground surface with ⅝-in (160-mm) steel or stainless steel rods extensions. The MDPT hammer configuration is or can be designed to stimulate the SPT tip and skin resistance behavior to produce 10% of the SPT total energy of 350 ft-lb (48.4 kg-m). The hammer consists of a 17.6 lb steel mass (7.98 kg) (hammer) falling 2 ft (609 mm) to develop 35 ft-lb (4.84 kg-m).

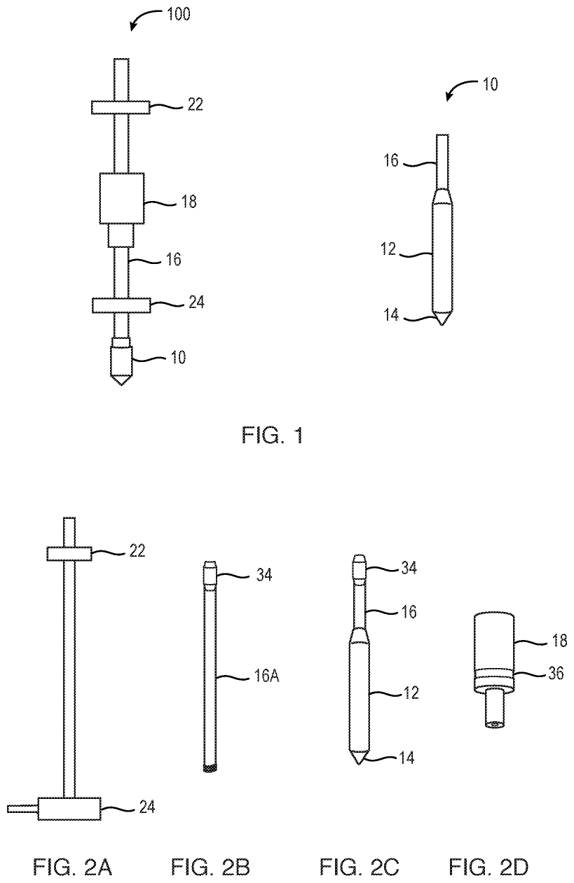

Referring to the figures, as shown in FIG. 1, according to at least one embodiment, a MDPT system as described herein includes a MDPT device 100. The MDPT device 100 includes the drive-weight assembly comprising a hammer 18, a top anvil 22 and a bottom impact anvil 24. The MDPT device 100 further includes a probe 10 at its lower end. The probe 10 defines a cylinder 12 with a cylindrical shape with a cone head 14 at a distal end of the probe 10 and a rod 16 attached at a proximal end of the probe 10, for example, with a torque handle. In one embodiment, the rod has a ⅝-in (160-mm) diameter. In one embodiment, the road is made of steel or stainless steel. The drive-weight assembly is configured for driving the probe 10 into soil, the drive-weight assembly including an approximately 17.5 lb hammer 18. The MDPT device 100 may further include one or more steel rod extensions that attach to the free end of rod 16. Typically, the MDPT test is continuously driven from the ground surface until a termination depth is reached. The cone has a 60° apex angle. The process of driving the cylindrical steel rod (CSR) with the 17.6 lb (7.94 kg) hammer is to lift the hammer 2 ft (0.6 m) and let it drop, forcing the anvil to drive the CSR into the soil. The total blow counts are recorded at 1-ft (0.3-m) intervals to the desired depth.

FIGS. 2A through 2D and FIG. 8 illustrate further schematic sketches of the MDPT device (interchangeable referred herein simply as “the MDPT”). The MDPT can be operated manually or automatically using a gear-motor. FIG. 2A illustrates a top part of the MDPT device that includes anvils that provide a 24-inch drop in height, in one embodiment. FIG. 2B illustrates an extension rod 16A with a coupler 34 provides at one of its ends. FIG. 2C illustrates rod 16 including a coupler 34 at its end opposing the end connected to cylinder 12 of probe 10. Probe 10 further includes a cone tip. FIG. 2D illustrates a drop weight or hammer 18 including a groove 36; in one embodiment, the hammer 18 weighs 17.5 lb. As shown in FIG. 2D, in one embodiment, the hammer (weight mass) can be marked with a groove 36 to distinguish it from the DCP (Dynamic Cone Penetrometer) hammer.

The MDPT device can be operated manually in some embodiments. In some alternate embodiments, the MDPT device can be operated automatically using a gear-motor that is configured to drive the probe within the soil. In one embodiment, the automatic or automated MDPT device can consist of a 35-lb (15.88-kg) hammer falling 1 ft (300 mm) to develop 35 ft-lb (4.84 kg-m). Theoretically, the 140-lb (63.5-kg) hammer of a SPT (Stander Penetration Test) device dropped from 30 in (762 mm) should deliver 350 ft-lb (48.4 kg-m) of energy (140 lb×30 in =350 ft-lb) (63.5 kg×0.762=48.4 kg-m) with each blow. In some embodiments, a single MDPT device can be operable both manually and automatically.

The system including the MDPT device was field-tested to measure the hammer energy efficiency and compare the data to the SPT energy efficiency. The energy transmitted to the steel rod from the hammer during the impact, determined by the F-V method (EFV) and the theoretical potential energy (ETR) values were 77%-94%. (Approximately between 27-33 ft-lb (3.7-4.6 kg-m)). The standard deviation for all data increments for EFV and ETR was 1.5 ft-lb (0.21 kg-m) and 4.2%, respectively. The energy measurement tests confirmed that the MDPT energy and efficiency are within the same range of the automatic hammer SPT energy and efficiency. The hammer efficiencies averaged 80% for both MDPT and automatic SPT; therefore, no correction was needed between the MDPT n80 values and SPT N80 values.

Further field testing indicated that the energy delivered to the rods during an automatic SPT test can vary from 68%-94% of the theoretical maximum, with an average of 81%. SPT resistance values are normalized to 60% energy, because the correlations made before the advent of hammer-system calibration used safety hammers and the correlations made at that time are generally assumed to have been running at 60% efficiency. The normalization is made in design to compare resistance values to published correlations that were either assumed to be operating at or otherwise normalized to 60%. However, the measured field energy for this research is corrected to the standard 60% energy, and thus each blow will deliver (350 ft-lb×0.6)=210 ft-lb (48.4×0.6=29 kg-m) to the sampler. Each blow count could be used as a unit measurement of delivered energy, in which one blow count equals 210 ft-lb (29 kg-m). The measured N value blows per ft (blows per 300 mm) is defined as the penetration resistance, which equals the sum of the number of blows required to drive the SPT sampler to a depth interval of 6-18 in (150-450 mm). The MDPT procedure is configured to encompass the same effect of friction and other factors to reduce the delivered energy.

There is no portable and rapidly deployable instrument currently available in the market that is capable of reaching to a minimum depth of 45 ft. (13.7 m) that is available drive deeper than the subgrade layers. In contrast, embodiments of the presently disclosed subject matter as disclosed herein can be advantageously driven to 45+ft. (13.7+m) below the ground surface with ⅝-in (16-mm) steel or stainless steel rods extensions.

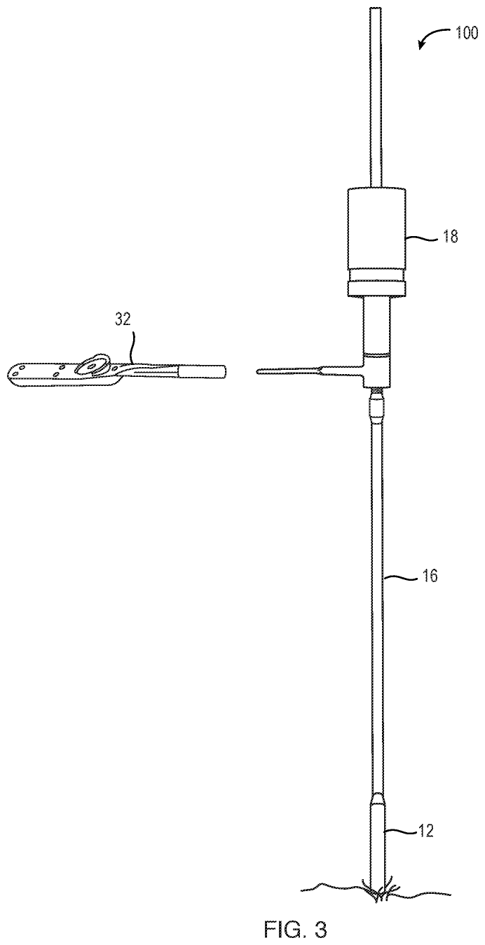

In one embodiment, the MDPT device consists of a graduated steel or stainless-steel rod with a cone head 12 inch (305 mm) long attached to one end and an anvil attached to the other end (see FIG. 3, for example). The MDPT hammer configuration is designed to mimic the SPT tip and skin resistance behavior to produce 10% of the SPT total energy of 350 ft-lb (48.4 kg-m). In some embodiments, the probe including the cone tip is configured to be left inside the soil after completion of soil test. In other words, the probe is disposable such that only the rod is retrieved from the hole created for soil testing after completion of the soil testing.

The equipment required for testing with the MDPT system includes a drive-weight assembly, a probe having a cylindrical shape with a steel cone head, and steel rod extensions. The MDPT device test procedure is performed by continuously driving from the ground surface until a termination depth is reached. The cone has a 60° apex angle. The drive-weight assembly consists of a 17.5-lb (7.9 kg) hammer and a ⅝-in (15.9 mm) diameter steel (or stainless steel) rod with two anvils (see FIG. 1, for example). In one embodiment, the process of driving the cylindrical steel cone head (CSCH) with the 17.5-lb (7.94 kg) hammer is to lift the hammer 2 ft (609 mm) and let it drop freely, causing the anvil to drive the CSCH into the soil. The total blow counts are recorded in 1-ft (0.3 m) intervals to the desired depth. The test can be performed adjacent to SPT boring or CPT soundings for local calibration.

The MDPT system and device was field-tested to measure the hammer energy efficiency and compare the data with SPT energy efficiency. The measurements were made using Pile Dynamics, Inc. Model PAX with strain and accelerometer. The energy transmitted to the steel rod from the hammer during the impact, as determined by the F-V method (EFV) and the theoretical potential energy (ETR) values, was approximately between 27-33 ft-lb (3.7-6 kg-m) and 77%-94%. The standard deviation for all data increments for EFV and ETR was 1.5 ft-lb (0.21 kg-m) and 4.2%, respectively. The energy measurement tests confirmed that the MDPT energy and efficiency are within the same range of the SPT energy and efficiency; therefore, no correction was needed between the MDPT values and SPT N values.

The MDPT tests were performed within 2 ft (610 mm) or less of the corresponding SPT test to limit spatial variability. The MDPT device was tested in different environments and the final configuration was selected. The reliability of the MDPT values is significantly influenced by its repeatability. The repeatability of the MDPT device was evaluated using the coefficient of variation based on 115 in-situ and laboratory tests in proximity to each other. The results of the analysis show that the MDPT has very good repeatability. The coefficient of variation analysis showed the range is between 4%-14%.

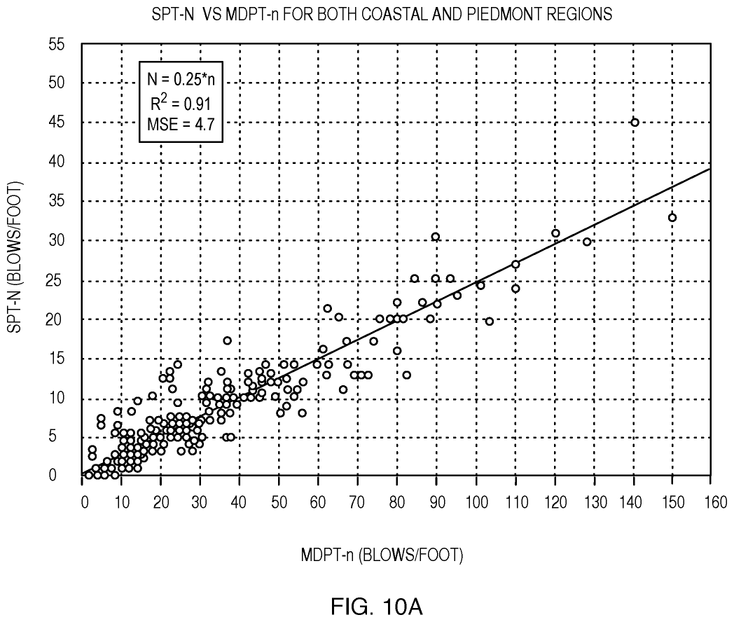

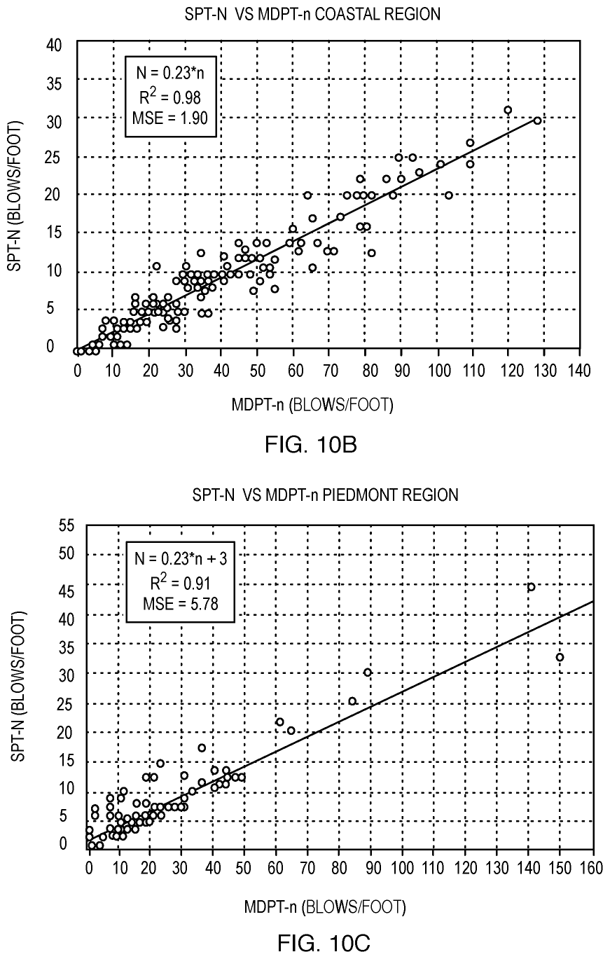

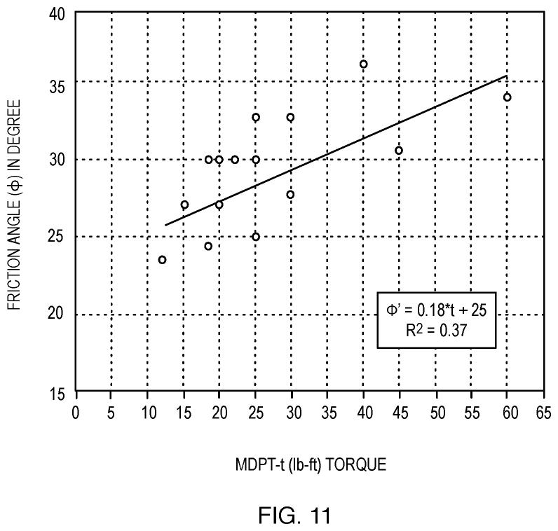

The MDPT n-value obtained from the MDPT device was correlated to the SPT N-value using well-established empirical methods. Establishing a relationship between the MDPT n-value data and the SPT N-value can provide a cost-effective method for assessing key soil parameters in the field. The MDPT-n values from the field measurements were recorded at the same elevation as those from the SPT (N-values) for the Piedmont and the Coastal Plain regions. Statistical analysis methods were used to determine the strength of the relationship between the SPT (N) and the MDPT-n values. The theoretical basis of the data interpretation was developed and verified in the field. The liner correlation was found to be the best fit for all graphs. The coefficients of determination R² in this study are very close to each other, and thus average correlations can be used for projects in both regions. This correlation is achieved regardless of soil type or the groundwater table. FIGS. 10A through 10C illustrate samples of the correlations study. The system as described herein is accordingly configured to measure a number of blows MDPT-n required for the probe to penetrate the soil by half a foot, one foot, or depth per blow, as needed.

It should also be noted that the MDPT is safer to use than the SPT because of its smaller size. A correlation of MDPT blow counts (n-value) to the SPT blow counts (N-value) for expediently assessing the strength of a wide range of soils to a depth of 45 ft was performed. The study focused on the Coastal Plain and the Piedmont regions of North Carolina. Data from the MDPT and the SPT were compiled, organized, and analyzed. Both the correlation coefficient (R) and the coefficient of determination (R²) indicated a strong positive linear relationship between the SPT (N) values and the MDPT-n values for both regions. MDPT expediently gives a continuous evaluation of the soil layers, while SPT commonly yields soil strength evaluations every 5 ft (1.6 m), thus increasing the risk of missing valuable information. In general, the MDPT was found to be a reliable method for assessing soil strength. The use of MDPT yields soil properties without heavy drill rigs and costly equipment. The MDPT data reduction approach can be improved with additional field testing and correlations to CPT and triaxial test data.

Geotechnical design depends on strength, stiffness, and other soil parameters. The use of conservatively estimated values of these parameters for design can increase construction costs, but realistic parameters obtained from appropriate in-situ testing can reduce these costs. The MDPT testing device can accordingly provide for a planning technique that can improve the subsurface investigation of a project before mobilizing expensive and heavy specialized equipment. Studies have shown that estimating the direct unit skin friction in the field during the investigation stage will improve the calculation of the required pile length tremendously, while poor estimation of the unit skin friction will cause many constructions claims and errors in orders of pile length. Most common in-situ tests such as the SPT-T are performed by using heavy drill rigs in conventional drilled borings. The SPT-T test typically involves a separate borehole to obtain soil data for correlation to a number of different design parameters, such as the angle of internal friction, shear strength, and unit skin friction—with the torque test representing a direct measurement of the unit skin friction and can assist in classifying the soil type.

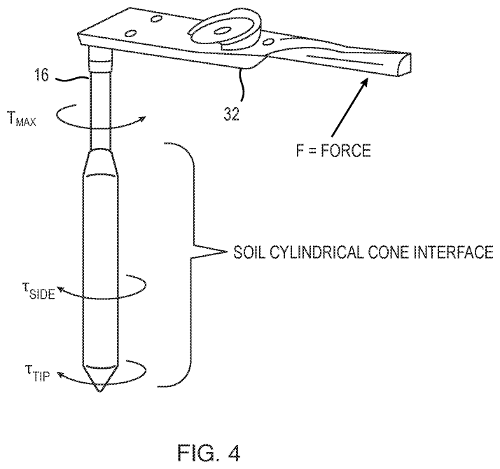

A MDPT device that is configured for further measuring a torque “t” (referred to herein as “MDPT-t device: or merely as “MDPT-t”) was developed with the following motivations: (1) portability for ease of access in many difficult terrains; (2) estimation of the unit skin friction by using a calibrated torque wrench; (3) easy evaluation of soil properties at different soil layers and depths. FIG. 3 and FIG. 4 illustrate a calibrated torque wrench 32 used for turning the MDPT device 100. As noted earlier, the MDPT system/device can be operated manually or automatically using a gear-motor. The MDPT device can be rotated with a torque wrench 32 to estimate soil properties (MDPT-t). Torque wrench 32 illustrated in FIG. 3 is configured to engage the MDPT device 100 in order to rotate the probe of a cylindrical shape with a 60 degree cone head. The MDPT-t can be useful for both sand and clay to a depth of about 40-45 ft (13.7 m) depending on the soil stiffness.

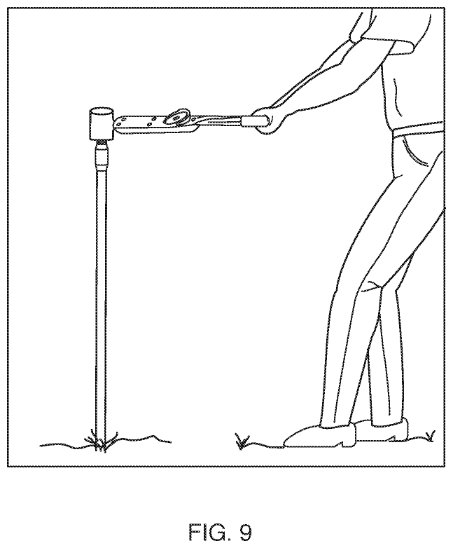

Accordingly, in one embodiment, an in-situ soil testing with the MDPT-t device involves driving the 12-in (305-mm) steel rod with the cone head into the soil layer to be tested and recording the number of blows for every 6 in (152 mm) of penetration. After driving the steel rod to a desired depth, a torque adapter for the torque wrench and/or torque wrench (shown in FIG. 3, FIG. 4 and FIG. 9) is connected to the top of the steel rod extension (alternately, the torque wrench can be coupled to a protrusion extending from the device 100, as shown, for example, in FIG. 3), and the torque wrench is used to rotate the steel rod and record the maximum torque value (lb-ft). FIG. 4 further illustrates a free-body diagram of the MDPT-t torque test. The torque force gradually increases when using a torque wrench to rotate the cylindrical cone until it overcomes the resistance from the soil to identify the maximum torque force at the desired depth. The direction of the applied maximum torque rotates the cylindrical cone in the opposite direction of the shearing stresses on the interfaces. The driving and torque test is repeated to the desired depth. The soil unit skin friction can be estimated from the torque measurements and steel rod dimensions, which is then used in pile design.

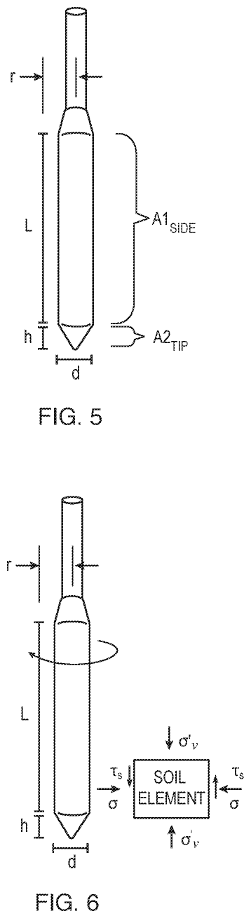

It should be noted that the shearing stresses form along a cylindrical cone, as shown in FIG. 6. The shear surfaces are at the interface between the soil and the side of the cylindrical cone (A1_{SIDE}) and cone head (A2_{TIP}), as shown in FIG. 5 and FIG. 6. FIG. 5 illustrates dimensions and parameters of the MDPT-t torque test. FIG. 6 illustrates the stress on a soil element adjacent to the steel rod after driving and torqueing.

The typical definition of torque is defined as a moment or moment force. The moment is calculated simply by multiplying the force by the arm. From FIG. 4:

T_{MAX}=F×r (5.9)

where T_{MAX} is the maximum measured torque (at the top of the adapter rod), F is the force, r is the arm (is the 0.5d) half the diameter of the cone, and d is the diameter of the cone=2.5 cm (1 in). From Equation 5.9, the force from the measured torque can be calculated by dividing the measured torque by the moment arm, as shown in Equation 5.10.

F=T_{MAX}/r (5.10)

The unit side friction (fs=τ_{SIDE}) acting on the cone surface area may be obtained by dividing the force (F) by the cone surface area (A1):

fs=F/(0.5d*A1) (5.11)

where A1 is the cylindrical cone surface area.

A1_{SIDE}=(2*π*0.5d*L)=(π*d*L) (5.12)

here L is the length of penetrated cone=1 ft, and d is 1 in.

fs=2T/(πd²L) (5.13)

The relationship between T_{MAX} and τ_{SIDE} is expressed in Equation 5.14

T_{MAX}=τ_{SIDE}(A1_{SIDE}) (5.14)

Equation 5.14 can be written as

T_{MAX}=τ_{SIDE}(2*π*r*L)*r (5.15)

or

T_{MAX}=τ_{SIDE}(0.5*π*d*L)*d

FIG. 5 shows the dimensions and parameters, where L is the length of the cylindrical shape, r is the radius, and h is the height of the cone shape at the base.

The cylindrical side shear provides most of the resistance (the surface area of the cone head is very small); therefore, Equation 5.11 ignores any contribution to the torque measurement from the cone head surface area at the base (tip) of the cone (ignore A2_{TIP}).

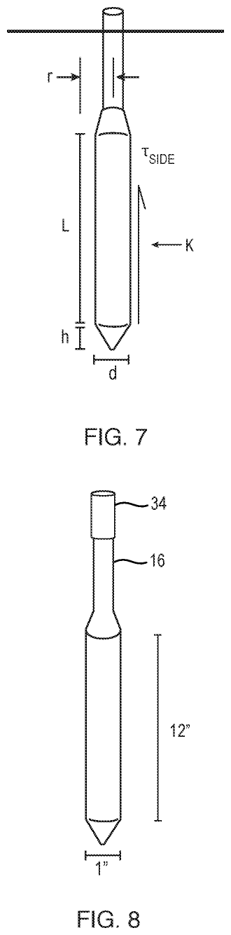

The MDPT-t tests can be performed to estimate the direct values of unit skin friction by using a torque wrench to rotate the steel cylindrical cone shape after driving to measure the corresponding maximum torque. In this sense, the MDPT-t acts as a mini pipe pile. There are two forms of soil resistance provided by the pile to the applied axial loads: shaft resistance and base resistance. Driven piles will mobilize the ultimate skin and tip resistance at each soil layer. FIG. 7 illustrates dimensions, parameters and side resistance of the MDPT-t torque test.

MDPT-t tests were performed to estimate the direct values of unit skin friction by using a torque wrench to rotate the steel cylindrical cone shape after driving to measure the corresponding maximum torque. In this sense, the MDPT-t acts as a mini pipe pile. There are two forms of soil resistance provided by the pile to the applied axial loads: shaft resistance and base resistance. Driven piles will mobilize the ultimate skin and tip resistance at each soil layer. The ultimate bearing capacity can be written as:

Qu=Qs+Qb (5.16)

where Qu is the ultimate pile capacity, Qs is the ultimate shaft resistance, and Qb is the ultimate base resistance.

Many researchers have studied and developed expressions for skin friction based on effective stress methods for driven piles in soft clay due to pore pressure dissipation. Chandler suggested using a design method based on the effective stress method, which assumes the interface soil is failing in shear.

τₛₖᵢₙ=Cᵤ COS ϕ′ (5.17)

The value of the Cᵤ is the undrained shear strength during the pile installation before pore water pressure dissipation. The value of the Cu will depend on the degree of the adjacent soil remolding during or after pile installation and the amount of strength gain from pore water pressure dissipation. Therefore, the value of the undrained shear strength in Equation 5.17 could be greater or less than the actual value of the undisturbed soil.

The focus of this study was to estimate the unit skin friction to determine the shaft resistance of the pile or the MDPT-t. Therefore, Qs is the shear strength of the soil multiplied by the surface area of shaft (MDPT-t) in contact with the soil.

For Clay Layers:

Qs=Cₐ*d*L (5.18)

For Sand Layers:

Qs=fs*d*L (5.19)

where Cₐ is the adhesion, fs is the unit skin friction, d is the diameter of the pile, and L is the length of pile in contact with the soil.

The soil mechanics theory indicates that the ultimate shaft friction for driven piles is related to the horizontal effective stress (σ′ₕ) acting on the shaft and the effective angle of friction between the pile and the soil (δ). Thus,

τ_{SIDE}=Ca+σ′h tan(δ) (5.20)

where τ_{SIDE} is the unit shaft friction at any point.

A further simplifying assumption is made that σ′ₕ is proportional to the vertical effective overburden pressure σ′ᵥ. Thus,

σ′ₕ=Kσ′ᵥ (5.21)

τ_{SIDE}=Kσ′ᵥ tan(δ) in sand (5.22)

where K is the earth pressure coefficient (see FIG. 7).

The τ_{SIDE} is found using Equation 5.23, where Cₐ is the adhesion between the cylindrical shape and the soil (steel and soil), σ′ᵥ is the effective vertical stress computed using the effective unit weight (γ′), and 6 is the soil-steel interface friction angle.

τ_{SIDE}=Cₐ+Kσ′ᵥ tan(δ) in clay (5.23)

σ′ᵥ=γ′*z (5.24)

Adhesion between the soil and the steel rod can be estimated by using FIG. 7 with a known cohesion value.

MDPT-t can be used to determine the skin friction between steel and soil using a similar relation as the vane shear test equation. Equation 5.13 can be used to estimate the unit skin friction using the measured torque from the MDPT-t device.

fs=2T/(πd²L) (5.13)

where fs is the unit skin friction, T is the maximum measured torque (ft-lb), L is the length of the 1 in-thick steel rod with cone head (L=12 in), and D is the outer diameter of the steel rod (d=1 in).

Equation 5.13 ignores any soil friction from the steel couplers for the steel rod extension due to the size of the couplers. The torque may be affected by the elastic deformation of the steel rods due to the length, as well as the many threaded connections at the coupler locations.

MDPT-t can be used to determine the skin friction between steel and soil using a similar relation as the vane shear test equation. FIG. 9, along with FIG. 8, illustrates MDPT-t torque rotation procedure. The filed test of the MDPT-t can performed according to the following steps: (a) drive the MDPT cone to the desired depth; (b) place adapter to the top of MDPT rod to attach a torque wrench to the adapter, and then turn the rods at a slow but continuous rate; and, (c) measure torque by taking readings at intervals of 10-20 s. Once the maximum torque is achieved and locked, rotate the wrench 360° twice. Adequate results can be achieved at a rotation speed ranging 5-8 rpm.

A single individual was able to perform the torque test throughout the test program in order to limit the variability of the maximum torque applied on each test. The force was applied using a 2-ft (0.91-m) torque wrench from the centerline of the MDPT extension steel rod (center line of hole). The torque wrench was rotated carefully to apply consistent force at a steady rate. The torque was completed by rotating 360° in order to prevent a false reading. After completing each test, the field data was compiled and transferred to a Microsoft Excel spreadsheet.

The MDPT device can accordingly provide a direct measurement of the unit skin friction from the torque test. The MDPT-t tests were performed in two different geological regions of North Carolina to produce empirical correlations. The MDPT-t unit skin friction was examined, and the results were promising. The unit skin friction produced by the MDPT-t device is within a reasonable range of the other reported values. In addition, the MDPT-t unit skin friction was examined and compared to the skin friction of other dynamic and static design methods such as CAPWAP, the Vesic design method, and APILE software, and the results were within acceptable range. Overall, the MDPT-t performance was acceptable and provided promising results. The results of this study shows that the use of a small and portable MDPT-t may serve as a quicker tool for site investigation and provide reasonable soil parameters for geotechnical engineers to use in planning, design, and analysis.

The MDPT was further correlated with CPT exploration to investigate the relationships between the MDPT and the CPT. Correlations were established between the cone tip resistance (qt), sleeve friction (fs), MDPT-n blow counts, and MDPT-t torque for two locations. In the static CPT test, a cone is pushed into the soil layers using the weight of the truck. During the penetration, the cone tip resistance (qt) and the sleeve friction (fs) are recorded continuously. The CPT is an excellent tool for profiling strata changes and providing soil characterization. The CPT test is more reliable for pile design purposes than the SPT test because the CPT data are more reliable and the cone penetration generates the cone tip resistance and sleeve friction similar to the pile bearing capacity. The CPT test consists of a cylindrical penetrometer with a conical tip that is mechanically pushed into the ground. It requires a heavy truck to generate sufficient force to push the cylindrical penetrometer into the ground. The CPT penetration has some similarity to the pile-loading mechanisms. Advantageously, the number of blow counts per ft of penetration (n) obtained from the MDPT during in-situ testing can be empirically correlated to the Cone Penetration Test (CPT) qt or sleeve friction fs. A positive linear relationship was found between the CPT tip stress qt, CPT sleeve stress fs, and the MDPT-n and MDPT-t torque for this study. In general, CPT qt versus MDPT-n showed higher correlation coefficients than CPT fs versus SPT(N).

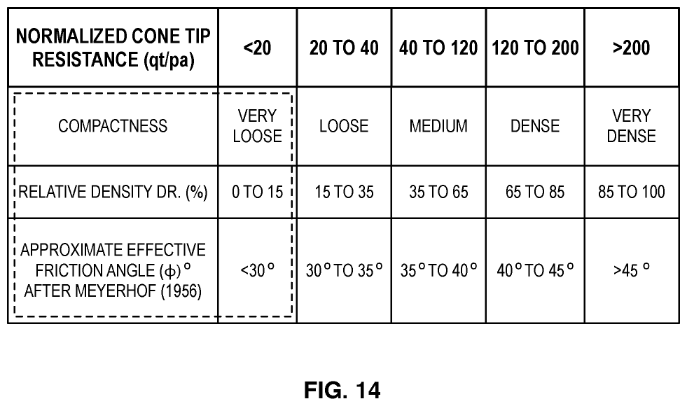

The Table in FIG. 14 illustrates the relationship between the cone tip resistance (qt) measured by the cone penetration test (CPT) and the effective friction angle ϕ′ of sands for different relative density ranging from very loose to very dense. The trend is proportional: as the cone resistance increases, the effective friction angle increases, as shown in the Table of FIG. 14.

Foundations are a critical and important part of structure construction. If the foundation material does not adequately support the design loads, excessive settlement or structure failure may occur; therefore, adequate in-situ testing is necessary for the success of the foundation design. The design engineer must be able to check and perform in-situ testing as needed, and the MDPT will fulfill this need. Some projects have limited and difficult access to the site for investigation, and thus cutting the access road or drilling through the bridge deck will increase the time and cost of the investigation. Similarly, verifying the bearing capacity for spread footing or retaining wall foundations can also be difficult to access during construction.

Using the MDPT as a quick, portable, and economical test device can improve the frequency of compaction testing during construction without delaying contact time. Increasing the testing frequency is essential to the stability and safety of pavement structures and roadway embankments. Field MDPT and DCP tests were performed at four sites in the Piedmont region of North Carolina. For each test location, soil density and moisture content were measured in-situ using a nuclear gauge at different depths and directions.

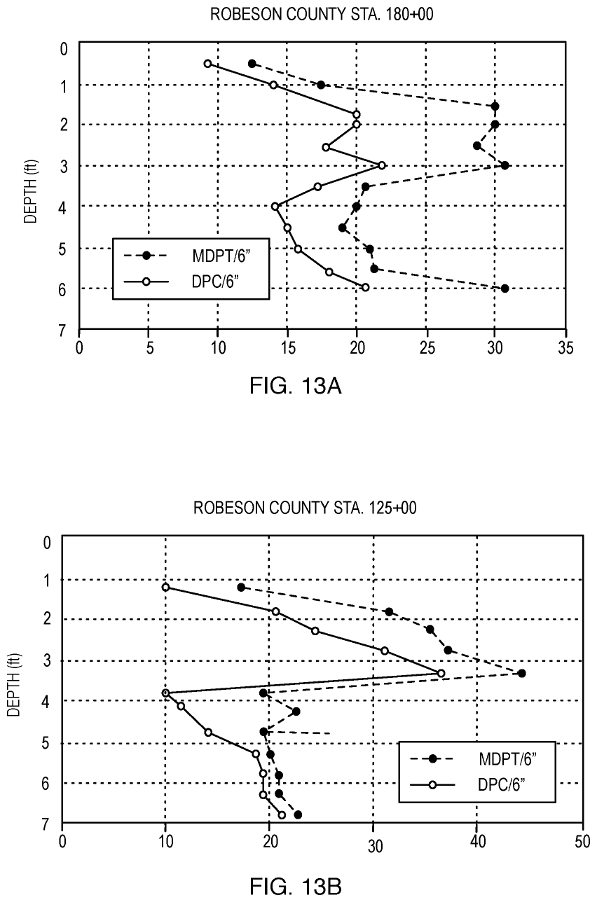

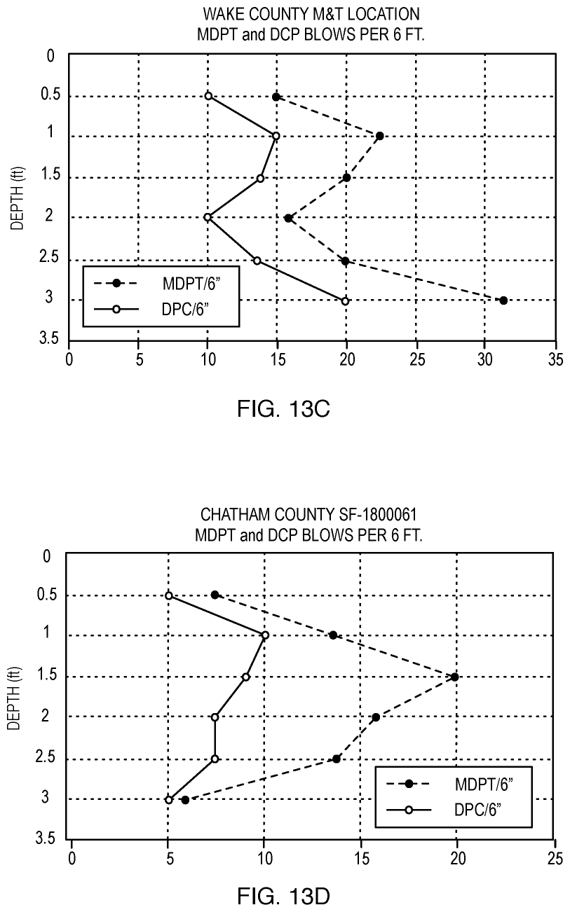

FIGS. 13A through 13D illustrate the field testing results of the MDPT blows and the DCP blows. The results obtained from these sites are very promising, and it is clear that the MDPT blows are higher than the DCP. The drop height and the mass weight for both the DCP and MDPT are almost similar, and the MDPT conical diameter (1 in) (25 mm) is slightly bigger than the DCP cone diameter, which is typically 0.787 in (20 mm). The DCP cone side is enlarged to minimize side resistance (skin) during penetration and thus the major driving resistance will be generated from the tip. On the other hand, the MDPT driving resistance will be generated from both the side and tip resistance. The higher blows of the MDPT could be due to the skin friction and size of the cone.

The MDPT penetration test does not require pre-auguring holes and can be driven up to 45 ft. or deeper depending on the soil strength; therefore, the MDPT performance is quicker and overcomes the penetration depth. Site-specific correlations will provide better results, improve the confidence level, and enhance the quality of the data.

The overall MDPT-t (fs) results versus SPT (N) blows per ft show a positive relationship compared with the results from other researchers. The variation of the relationship can be influenced by the regional soil characteristics and the distance and depths of these tests from each other. The MDPT-t unit skin friction was examined and compared with the unit skin friction of dynamic and static design methods, such as CAPWAP, Vesic, and APILE programs, which determined that both the unit skin friction and the results were reasonable and promising. The MDPT was correlated to limited data with CPT exploration to evaluate the relationship between the CPT and MDPT. The collected data showed a strong correlation between the estimated SPT* (N) from MDPT-n with the coefficient of determination of R²=0.87.

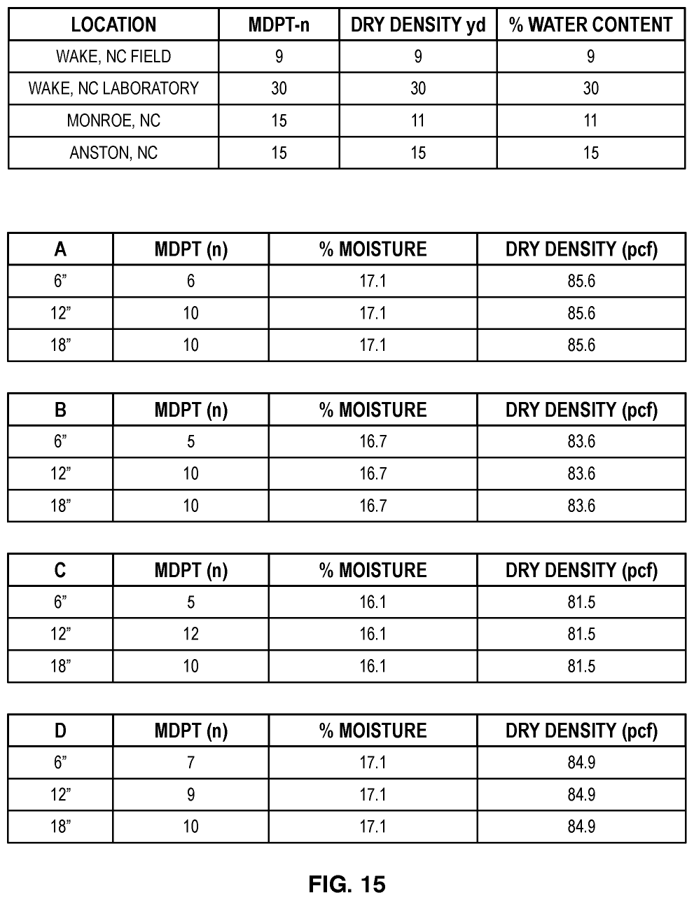

The penetration resistance MDPT-n value obtained using the MDPT was compared against the values obtained from traditional tests such as the standard penetration test SPT (N), cone penetration test (CPT), tip resistance (qt), and dry density γd and the results were found to be encouraging. Similarly, the MDPT-n blows per ft, the MDPT-t torque generated from the rotation of the cone using a torque wrench with soil shear strength were compared with the traditional CPT sleeve friction (fs) and the results were found to be encouraging. The test results show that the MDPT-n will produce three to five blows/ft for each SPT (N) blow/ft. On average, the correlation shows that MDPT-n approximately =SPT (N)*4. The upper and lower tables found in FIG. 15 show the relationship between MDPT-n and dry density γd and moisture content.

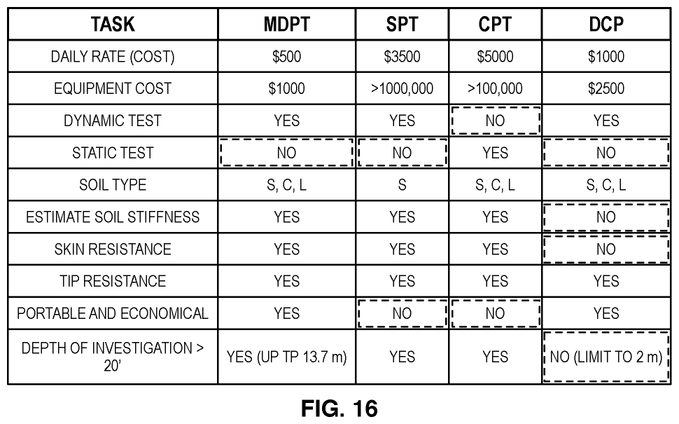

FIG. 15 illustrates tables showing the relationship between MDPT-n and dry density γd and moisture content. FIG. 14 illustrates a table showing the relationship between the cone tip resistance (qt) measured by the cone penetration test (CPT) and the effective friction angle ϕ′ of sands for different relative density ranging from very loose to very dense. FIG. 16 illustrates a table showing an overall comparison between the MDPT device and other in-situ test equipment.

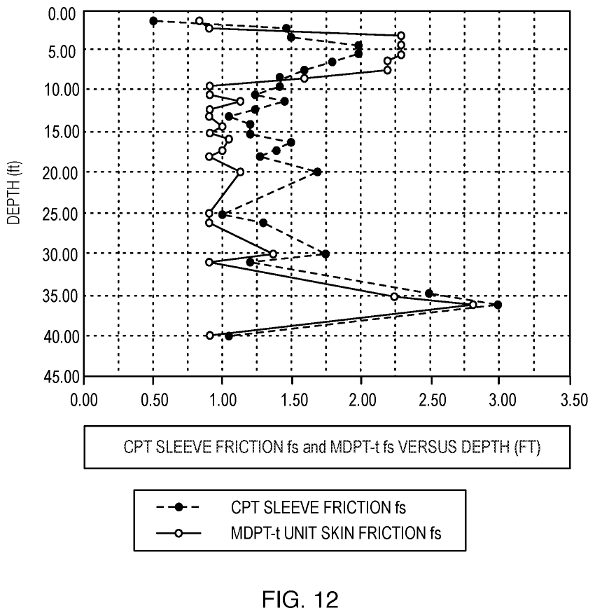

Overall, the results indicate the MDPT is a very useful device for design engineers and is capable of providing valuable soil properties quickly and more economically. Due to its behavior (generating skin and tip resistance) and its multiple applications, the MDPT tool is superior to similar devices that can quickly verify the accuracy and quality of the in-situ SPT and CPT results. FIG. 12 shows the comparison between MDPT-t unit skin friction fs and CPT sleeve friction fs with depths.

The MDPT n-value obtained from the MDPT device was correlated to the SPT N-value generated from an automatic hammer through the use of well-established empirical methods. Establishing the relationship between the MDPT-n data and the N-value advantageously provide a cost-effective method for assessing key soil parameters in the field. For correlation tests, the obtained data may be correlated to several different design parameters such as relative density, angle of internal friction, and shear strength. The torque test is a direct measurement of the unit skin friction and can help in classifying the soil type. The data points of the MDPT tests were compiled and organized for each geologic region. Comparisons between the MDPT blow counts (n) and the SPT blow counts (N) using an automatic hammer was made separately for the Coastal region and for the Piedmont region, and the results were encouraging. Based on the correlation and calibration tables developed for MDPT and SPT tests, the SPT-N values could be corrected based on the MDPT-n results adjacent to the SPT location. Development of site-specific correlations between SPT (N) values and the MDPT-n value can prevent many errors in design caused by using the wrong SPT (N) values.

The MDPT test can be used to indirectly estimate the bearing pressure by using the developed correlation between the MDPT-n, SPT, CPT, and DCP. Unlike DCP penetration tests, the MDPT penetration test does not require pre-auguring holes and can be driven to more than twice the depths of the DCP test; the MDPT is faster and can be driven deeper than the DCP. However, it is realized that site-specific correlations will provide better results, improve the confidence level, and enhance the quality of the data.

It is advisable to calibrate the MDPT device for each project in order to obtain accurate results and provide field quality control. The calibration process can be incorporated with the subsurface investigation plan in locations where the soil engineering properties are necessary for design and construction. The calibration should include laboratory tests such as triaxial shear, unconfined compression, and consolidation tests, if needed. The MDPT device is not necessarily proposed as a replacement for the SPT, CPT, DCP, or vane tests, but rather as another tool that may be used in many geotechnical tasks.

The MDPT device can be used to verify the specific density requirement in the field at any location or depth. It can estimate the dry density by calibrating the MDPT blow counts with a few density tests, and estimate the field density by using the developed empirical equation. The MDPT-n can also evaluate the dry density of soil layers to any depth quickly and economically. Comprehensive testing was conducted to evaluate the MDPT's correlations and to estimate the reliability and repeatability of the soil properties. The CPT, SPT, unit skin friction fs, moisture content and dry density γd correlations were analyzed and the results were encouraging, demonstrating reliable MDPT correlations.

Small and simple projects tend to cost as much as complex projects, because the cost to use conventional methods such as SPT and (CPT) are usually based on the number and depth of holes, location of the project, and time to complete the project. The test equipment and procedures for geotechnical applications are not as advanced as in other engineering disciplines. By contrast, embodiments of the presently disclosed subject matter can provide for a small, portable, and simple device with an inexpensive test procedure that can be performed by one person and correlated to conventional test methods; the MDPT-t device as disclosed herein can lead to considerable savings for geotechnical analyses and design.

The current practice for soil testing, according to FHWA, AASHTO (American Association of State Highway and Transportation Officials), and almost all state DOTs, is the SPT and CPT for small or large projects. A portable and mini device to simulate both the SPT and CPT mechanism for a variety of correlations can be advantageous. The MDPT can be used for many geotechnical tasks. It can give a continuous evaluation of the soil layers, unlike the SPT test, which provides soil evaluations every 5 ft (1.5 m) and risks missing valuable information about the soil characteristics by skipping 5-ft (1.5-m) increments. The table in FIG. 16 shows the overall comparison between the MDPT device and other in-situ test equipment.

In-situ test results from MDPT demonstrate that the soil properties can be estimated from portable dynamic penetration test data obtained from the MDPT-t device without the use of heavy and costly drill rigs or trucks. The MDPT can be used to evaluate subgrade and soil layer strength, as well as estimate soil properties using correlations with other in-situ testing methods.

As a portable and economical in-situ tool, the MDPT device can provide planning engineers, design engineers, construction engineers and inspectors with the necessary data to improve their work. The development of the MDPT device proves to be useful, economical, portable, and simple to use, and thus it can be an alternative to conventional methods of in-situ soil strength determination such as SPT and CPT. The MDPT device provides quick and accurate in-situ verification of the bearing capacities of shallow foundations and estimation of soil properties, and it can be used without heavy drilling rigs or trucks. In addition, the development of a non-electronic, portable, manual device will greatly reduce the breakup time and malfunction. The MDPT device can be operated by one person and used for many tasks, such as: (1) estimating the rock or refusal elevation without mobilizing the drill rig and three crew members at a cost of $3,500/day compared with $500/day for the MDPT; (2) estimating the pile embedment for unknown foundation bridges; (3) estimating the unit skin friction to assist the design engineer with pile foundation design; (4) evaluating the California Bearing Ratio blow counts versus depth for pavement design; (5) evaluating or verifying the bore holes completed by SPT more quickly and economically; (6) improving safety when using smaller equipment; (7) using the developed relationships between the MDPT test results and other commonly used foundation parameters; (8) estimating bearing capacity, density, and relative density; (9) reducing the number of bore holes required for bridge foundation design, as specified by NCDOT guidelines; only few boreholes are needed to calibrate the MDPT, which can then be used to complete the investigation; and, (10) evaluating the strength of the soil layers (blow counts) without mobilizing specialized equipment, thereby reducing costs and expediting work.

As to the above, they are merely specific embodiments of the presently disclosed subject matter. However, the scope of protection is not limited thereto, and within the disclosed technical scope, any modifications or substitutions that a person skilled in the art could readily conceive of should fall within the scope of protection of the presently disclosed subject matter. Thus, the scope of protection shall be determined by the scope of protection of the appended claims.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A system for in-situ soil testing, the system comprising:
a portable mini dynamic penetration test (MDPT) device including a probe for penetrating into soil, the probe defining a cylinder with a cone head at a distal end and a rod attached at a proximal end, and a drive-weight assembly for driving the probe into soil, the drive-weight assembly including an approximately 17.5 lb hammer,
whereby, in operation, the MDPT device is configured for use by an operator, wherein the operator can carry the MDPT device to a soil test site, set up the MDPT device at the soil test site, and test soil condition at the test site with the MDPT device.

2. The system of claim 1, wherein the drive-weight assembly comprises a hammer configured to provide an approximately 24-inch drop in height for driving the probe into the soil.

3. The system of claim 1, wherein the drive-weight assembly is configured for application of approximately 35 ft-lb energy to drive the probe into soil.

4. The system of claim 1, further comprising:
an extension rod with a coupler for coupling to the rod; and
a torque wrench configured to rotate the probe.

5. The system of claim 1, wherein the cone head makes a 60-degree apex angle.

6. The system of claim 1, wherein the probe is configured to be driven to a depth of at least 45 feet below a ground surface.

7. The system of claim 1, wherein the system is configured for one or more of:
automatic operation using a gear motor, and manual operation.

8. The system of claim 2, wherein the probe is configured to be left inside the soil after completion of soil test.

9. The system of claim 1, wherein one or more of the probe and the rod comprise steel or stainless steel.

10. The system of claim 1, wherein a number of blows required for the probe to penetrate the soil by one foot (MDPT-n) is related to one or more of: a dry density value of the soil, a moisture content of the soil, an effective friction angle ϕ of the soil, and a Dynamic Cone Penetrometer (DCP) blow count obtained from conventional equipment.

11. A method of in-situ soil testing, the method comprising:
providing a portable mini dynamic penetration test (MDPT) device, the MDPT device including:
a probe for penetrating into soil, the probe defining a cylinder with a cone head at a distal end of the probe and a rod attached at a proximal end of the probe, and
a drive-weight assembly for driving the probe into soil, the drive-weight assembly including an approximately 17.5 lb hammer;
carrying of the MDPT device by an operator to a soil test site; and,
testing soil condition at the test site with the MDPT device.

12. The method of claim 11, further comprising applying approximately 35 ft-lb of energy to drive the probe into soil.

13. The method of claim 11, further comprising measuring a penetration depth of the probe within soil for each blow to the probe by the drive-weight assembly.

14. The method of claim 11, further comprising measuring a number of blows required for the probe to penetrate soil by one foot (MDPT-n).

15. The method of claim 11, further comprising measuring a unit skin friction value of a surface of the probe (MDPT fs) when the probe is rotated by application of a torque of value MDPT-t.

16. The method of claim 11, further comprising measuring soil shear strength with the MDPT device.

17. The method of claim 11, further comprising calibrating test results obtained from the MDPT device by comparing them to one or more of: a standard penetration test SPT(N) value, a standard cone penetration test (CPT) value, a standard tip resistance (qt) value, and a standard dry density (γd) value, obtained from a conventional equipment.

18. The method of claim 11, further comprising comparing a number of blows required for the probe to penetrate soil by one foot (MDPT-n) to one or more of: a standard penetration test count (SPT-N) obtained from conventional equipment, and a standard Dynamic Cone Penetrometer (DCP) blow count obtained from conventional equipment.

19. The method of claim 11, further comprising comparing a unit skin friction value of a surface of the probe (MDPT fs) measured by the MDPT device with a cone penetration test sleeve friction value (CPT-fs) obtained from conventional equipment.

20. The method of claim 11, further comprising using a number of blows required for the probe to penetrate soil by one foot (MDPT-n) to calculate one or more of: a dry density value of the soil, a moisture content of the soil, and an effective friction angle ϕ of the soil.
